(19) United States
(12) Patent Application Publication
(10) Pub. No.: US 2002/0152300 A1
(43) Pub. Date: Oct. 17, 2002

(54) Internet shopping assistant

(75) Inventors: Martin Holley, Vienna (AT); Karin Huber, Vienna (AT)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/120,701

(22) Filed: Apr. 11, 2002

(30) Foreign Application Priority Data
Apr. 13, 2001 (EP) 01 890 115.7

(51) Int. Cl. G06F 15/173

(52) U.S. Cl. 709/223

(57) ABSTRACT

The invention relates to a method of supporting the dialog between a user and a target device and a computer for editing the information for a target device to support the communication between a user and the target device and also to a computer program product with which the steps in accordance with the method can be executed. In order to provide such a method and such a computer, by which a simple dialog between the user and a target device and a wide application, that is not just restricted to computers on the Internet, can be achieved, it is envisaged that the user is identified and user-specific data, which are used when editing the information for the target device are stored in a database. A computer (4) for editing the information for a target device (2) to support the communication between a user and the target device (2) has a communication means (1) for communication between the user and the target device (2), an interface (5) between the computer (4) and the target device (2) and a link between the computer (4) and the communication means (1) with a database (6) linked to the computer (4) for storage of user-specific data as well as identification means (7) for identification of the user.

The invention relates to a method of supporting the dialogue between a user and a target device. A target device is understood to mean, for example, a computer of a provider on the Internet, via which the user or customer can acquire a certain product or a certain service. The term target device also covers household appliances, such as video recorders, kitchen appliances or heating systems which also require input from a user to activate or control them. Apart from these devices in the private sector, industrial equipment can also be included under the term target device.

The invention also relates to a computer for editing the information for a target device to support the communication between a user and the target device.

The invention further relates to a computer program product which can be loaded directly into the internal memory of a digital computer and comprises sections of software code.

The importance of electronic trade is increasing at a tremendous rate due to worldwide data networks, in particular the Internet, or similar communications media. Modem electronic trade, known by the term e-commerce, is increasingly changing the behavior of consumers. Since the consumer no longer needs to buy or receive the goods or services from a business or a service company in person, the number of goods and services on offer can be increased considerably. At the press of a button on a computer terminal suppliers of the most varied of products or services from around the world can be brought to the customer. Because of this abundance of offerings, however, there is also a difficulty in finding the correct address on the Internet, for example.

But in other areas of daily life as well, such as the operation of household appliances or industrial equipment, problems that are further amplified by the pace of modem life always arise because of the rapid changes in technology. Furthermore, modem communications media such as mobile radio networks or data networks such as the Internet open up possibilities of operating such devices from virtually anywhere using simple communication means, such as mobile telephones.

So there is a great need for methods or devices to support the dialog between a user and a target device.

A method of the type in question is described for example in WO 00/63837 A1, in which user-specific data are evaluated for more efficiently searching for websites on the Internet. Operation is simplified by a speech processor. Neural networks provide an adaptive system.

WO 00/51050 A1 describes a method that supports finding the correct address on the Internet in electronic trade. Here the personal needs of the user or customer are taken into account when corresponding homepages are searched for. This takes place by storing a number of products in a database along with at least one preference criterion for each product as well as the storage of information about the user, such as size of clothes, certain tastes in music, sport, entertainment, films or books, or date of birth. The system provides a recommendation for certain products or similar generated in accordance with the user profile.

U.S. Pat. No. 5,970,469 A describes a method of supporting Internet sales in which the purchasing behavior of the purchaser in the past can be used in processing. With this system the information on the purchaser is combined with other data and a corresponding proposal made to the customer.

The known method has proven to have the disadvantage that communication with the Internet is supported only inadequately or the dialog with other target devices, such as household appliances or similar, is not supported at all. Furthermore, there is no method by which, for example, electronic sales procedures can be supported in such a way that input is simplified and thus also with, for example, mobile telephones or other hand-held devices, such as palm-top computers, an order can be placed on the Internet in a fast and simple manner.

Accordingly, the object of the invention is to provide a method of supporting the dialog between a user and a target device as well as a computer for editing the information for a target device to support communications between a user and the target device, through which a simpler dialog between the user and a target device and an extensive application, that is not just restricted to computers on the Internet, can be achieved. In particular, the method or the computer must be adaptive, which means that for recurring dialog between user and target device it can learn the corresponding steps of the method or the preconditions over time and apply them as necessary, so that the necessary steps for performing the dialog between user and target device are simplified.

To achieve this object in respect of the method, it is provided that the user will be identified and user-specific data stored in a database, which data will be called up when the information for the target device is edited. When a user accesses the system for the first time, the latter detects this and stores certain user-specific data in the database. The data so stored may be that which normally occurs during a dialog between the user and the target device or also certain user-specific data, such as name or address can be established for the user and stored in the database. When the information necessary for the target device is edited, such as the data necessary for completing an order form on a computer on the Internet, the user-specific data stored in the database where available are used. Any missing data is established through dialog with the user and stored in the database and also passed on to the target device.

Advantageously, the user is identified by his speech input. This requires no manual input from the user, which in particular with small operating devices, such as mobile telephones, represents a considerable simplification. Thus it is not necessary to enter certain passwords or similar for identification purposes by laborious use of the keys. The devices required for the speech analysis can, for example, be provided in the actual communication means of the user or in the computer for the editing of the information for a target device. Identification of the user can take place by analysis of any speech input or by analysis of specified speech input such as code words or the like.

Alternatively or additionally for the identification by means of speech input, in the case of communication between the user and the target device via a mobile telephone the former can also be automatically identified by means of his mobile telephone number. In the GSM (Global System for Mobile Communication) mobile telephone network such functions are implemented as standard, allowing display of the number of the calling subscriber at the called subscriber. With this function, an additional or alternative identification of the user can therefore take place when the mobile telephone is used.

Furthermore or as an alternative to the possibilities stated, an identification can also take place by entering a password, an identifier, a PIN code or the like. To this end a credit card number, social security number or other clear identifier of the user can be used.

Depending on the application it may be an advantage for the dialog between the user and the target device to be encrypted. For this purpose normal encryption and decryption methods can be used.

In the event that the information required by the target device is not all available in the database, this information is established through a dialog with the user. To this end a communication is established by means of a computer for example, and the user is asked a corresponding question that the user answers preferably by speech input by means of his communication means, such as a mobile telephone. Depending upon the communication means used, manual input via keys or similar can also take place.

The user-specific data are preferably updated and expanded regularly, while a confirmation from the user is preferably requested before any updating so as to avoid or at least reduce incorrect entries.

To simplify communications between the target device and the user, synthetic speech output can be provided that returns the information from the target device to the user in acoustic form. This possibility is particularly advantageous when a mobile telephone is used as the communication means between the user and the target device.

If the information transferred by the user to the target device is restricted as a function of the user, a restriction of the possible transactions can be achieved, which is for example advisable when the method in accordance with the invention is used by children, but also in other areas.

To achieve the object according to the invention, also a computer is used for editing information for a target device to support communication between a user and the target device, comprising a communication means for communication between the user and the target device, an interface between the computer and the target device and a link between the computer and the communication means, with a database linked to the computer for storage of user-specific data and identification means for the identification of the user. The interface between the computer and the target device may be, for example, a respective link to a data network such as the Internet, or also a standardized or individually designed link to a device such as a video recorder, a heating system or a kitchen appliance. The communication or dialog, respectively, between a user and the target device is interrupted by the computer and through regular querying of the database the dialog between the user and the target is supported in that data which is present and which the target device needs, is taken from the database and thus need not be entered by the user via the communication means. Furthermore the inventive method is built up as an adaptive system, in that user-specific data are regularly updated and expanded in the database and thus the data file of the user is continually updated and expanded. User-specific data, such as name, address, date of birth, but also certain preferences, can be called up so as to support the dialog with a target unit.

The identification means are preferably in the form of a speech recognition unit. With the appropriate speech input by the user, it is immediately assigned to the corresponding user-specific data in the database and the further dialog with the target unit is thereby supported.

In accordance with a further characteristic of the invention, encryption and decryption means for encrypting and decrypting communications between the user and the computer and/or communication between the computer and the target device are provided. Such encryption is important to secure personal data and thus protect the privacy of the user. For financial transactions in particular, such encryption is also a protection against abuse by others.

If acoustic references for the speech recognition and/or information on the purchasing behavior of the user or similar are provided in the database, the corresponding support for the dialog and the identification of the user is further enhanced.

Furthermore, a recognition device for recognition of the communication means can also be provided. This recognition device may be effected, for example, in the event of use of a mobile telephone as the communication means, by means of the mobile telephone number that always accompanies a call.

In accordance with another characteristic of the invention, the interface between the computer and the target device is formed by a data network, in particular the Internet.

In respective fields of application the communication means can be integrated with the computer. For example, a home computer may serve both as a communication means and a computer for editing the information for the target device.

This also applies to the database for the user-specific data that can be integrated with the computer.

For acoustic output of the information to the user a voice synthesis device may be provided. Through acoustic output the dialog between the user and the target device is further enhanced, since reading of a display or similar is unnecessary.

For user-specific restriction of the information transferred by a user to the target device a corresponding device or entry in the database can be provided. In this way, by way of example, a parental control or other access restriction can be created.

The communication means may be in the form of a mobile telephone through which the target device can be reached from virtually anywhere.

To achieve the object according to the invention also a computer program product is used that can be loaded directly into the internal memory of a digital computer and comprises sections of software code, in which the computer is used to process the steps of the method described above if the product is running on the computer.

For this purpose the computer program product is preferably stored on a medium that can be read by a computer.

The present invention is further explained using preferred examples of embodiment and with reference to the drawing, in which

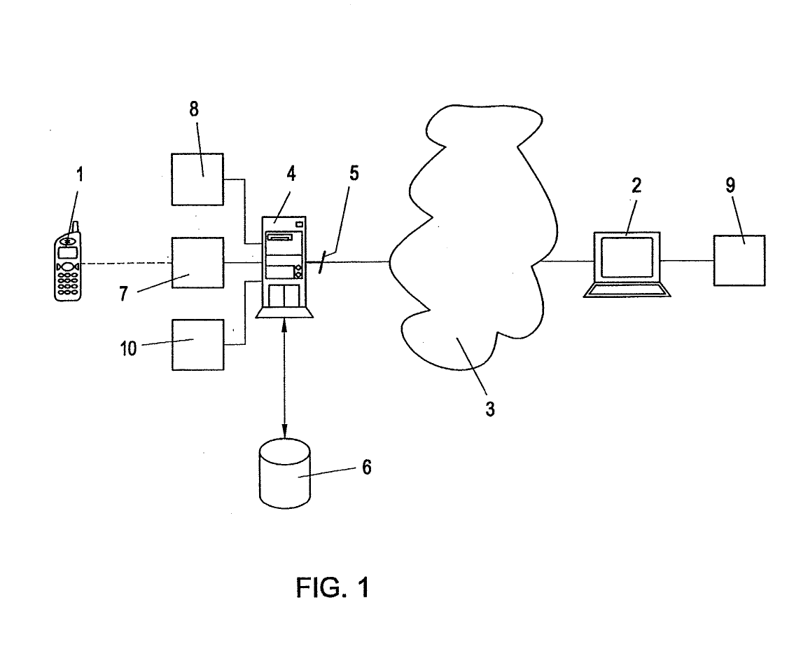

FIG. 1 shows in a schematic manner the components for executing the method in accordance with the invention during dialog between a user and a computer on the Internet.

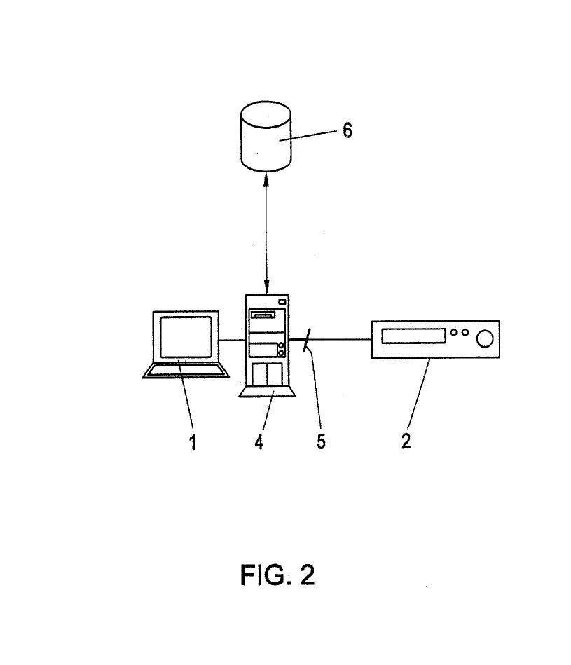

FIG. 2 shows the components for executing the method in accordance with the invention to support the dialog between a user and a household appliance.

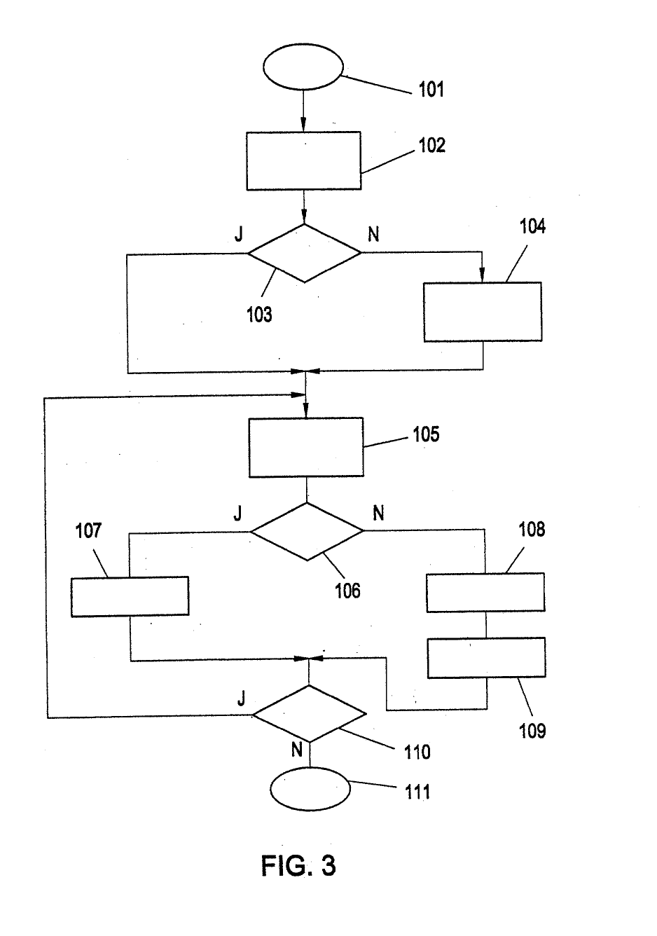

FIG. 3 shows a flow chart to illustrate the functional sequence of the method in accordance with the invention.

FIG. 1 shows a communication means 1 in the form of a mobile telephone, with which a user establishes a dialog with a target device 2, which target device 2 in the present case is comprised of a computer that is connected to a data network, in particular the Internet 3. Instead of the use of a mobile telephone as the communication means 1 a personal computer, a palm-top computer or the like may be provided. The target device 2 in the form of a computer can for example be a server of a provider of certain products on the Internet 3. In accordance with the invention a computer 4 is provided that serves to edit the information for the target device 2 to support the communication between the user and the target device 2.

The computer 4 has an interface 5 with the target device 2, that can be comprised of a corresponding link to the Internet 3, for example by means of a modem link. The interface 5 can also be comprised of a standard interface of the computer 4. Likewise there is a link between the computer 4 and the communication means 1, which by way of example can be comprised of the corresponding mobile radio network and a corresponding receiver unit on the computer 4 (not shown).

In accordance with the invention a database 6 is also provided for storage of user-specific data, which is preferably integrated with the computer 4. Depending on the application the communication means 1, the computer 4 and the database 6 can also be combined to a single device. During the dialog between the user and the target device 2 according to the invention user-specific data are searched for in the database 6 and these data are used for the information for the target device 2 as required. In the case of the first communication from the user the most important user-specific data are entered by the user when requested via the communication means 1 and stored in the database 6 via the computer 4. Identification means 7 are used to identify the user and can, for example, be comprised of a speech recognition unit, with which automatic assignment to the respective user takes place through the corresponding speech input of the user via the communication means 1. The identification can also be extended to the entry of a password, an identifier, a PIN code or similar or take place automatically through the mobile telephone number of a mobile telephone as the communication means 1. In order to prevent abuse and to ensure data protection, the communication between the mobile telephone 1 and the computer 4 and/or the computer 4 and the target device 2 can also take place via corresponding encryption and decryption devices 8, 9. These encryption and decryption devices 8, 9 are naturally preferably integrated with the computer 4 or with the target device 2. For output of the data transferred from the target device 2 or computer 4 to the user or communication means 1 in acoustic form a speech synthesis device 10 can also be provided.

FIG. 2 shows a realization of the method in accordance with the invention in the support of the dialog between a user and a target device 2 in the form of a domestic appliance, for example a video recorder. In this case the communication means 1 of the user is formed by a personal computer that also contains the function of the computer 4. Via a corresponding interface 5 the target device or video recorder is connected to the computer 4. Through according identification of the user, for example by the entry of a password, the user-specific information stored in the database 6 is used for programming the video recorder and thus supports the programming process. In this way different behaviors of family members can be taken into account and used when programming the video recorder.

The application in accordance with the invention of the method or computer or computer program product in accordance with the invention is, however, not restricted to the two examples described. Rather, the invention allows a very wide range of applications in the most varied of fields. For example, the dialog of a user with a heating system or kitchen appliances can be supported and simplified. Furthermore, it is conceivable for the method in accordance with the invention to also support the completion of forms, for example from authorities over the Internet.

FIG. 3 shows a flow chart of the most important functional sequences of the method in accordance with the invention. The method in accordance with the invention begins at step 101. At step 102 identification of the user takes place, for example by analysis of speech input. At step 103 a query takes place on whether data on the identified user is present in the database. If this is the case, the sequence continues from step 105. If the user is a new user and if, accordingly, no user data is present in the database, in accordance with step 104, certain user data is demanded from the user and stored in the database. In accordance with step 105 the target device is asked for desired data, whereupon, in accordance with step 106, a search is made to see if these data are present in the database. If the data desired by the target device are stored in the database, these are called up from the database in step 107 and transferred to the target device. In the event of the desired data not being stored in the database, they are established from the user in step 108 and passed to the target device and, in accordance with step 109, stored in the database. The procedure continues with a query in accordance with step 110 on whether further data are required for the target device and in the affirmative it continues with step 105. This loop between step 110 and step 105 is repeated as often as necessary. If all the data required for the target device are present, the procedure is ended in accordance with step 111.

Mention may be made of the fact that the user identified by the computer can by speech input also ask quite general questions or also questions in a purchasing procedure. For example, the user can ask when the book ordered from the target device will be delivered. The computer recognizes the content of the question and converts this into a question that can be answered by the target device, which answers the question to the computer. With the speech synthesis means of the computer the computer answers the question of the user.

1. A method of supporting the dialog between a user and a target device (2), in which the user is identified and user-specific data are stored in a database (6) that are used when the information for the target device (2) is edited.

2. A method as claimed in claim 1, in which the user is identified on the basis of his speech input.

3. A method as claimed in claim 1, in which the user communicates with the target device (2) via a mobile telephone (1) and the user is identified on the basis of his mobile telephone number.

4. A method as claimed in claim 1, in which the user is identified on the basis of the input of a password or an identifier, a PIN code or similar.

5. A method as claimed in claim 1, in which the dialog between the user and the target device (2) is encrypted.

6. A method as claimed in claim 1, in which information that is missing for the target device (2) is determined through a dialog with the user.

7. A method as claimed in claim 1, in which the user-specific data are updated and extended.

8. A method as claimed in claim 1, in which in the case of different user-specific data entered by the user and stored in the database (6), confirmation of the user is required for updating of the user-specific data.

9. A method as claimed in claim 1, in which the communication between the target device (2) and the user takes place via synthetic voice output.

10. A method as claimed in claim 1, in which the information transferred by the user to the target device is restricted in dependence on the user.

11. A computer (4) for editing information for a target device (2) to support communication between a user and the target device (2), comprising a communication means (1) for communication between the user and the target device (2), an interface (5) between the computer (4) and the target device (2) and a link between the computer (4) and the communication means (1), with a database (6) linked to the computer (4) for storage of user-specific data, and identification means (7) for the identification of the user.

12. A computer as claimed in claim 11, in which the identification means are formed by a speech recognition unit.

13. A computer as claimed in claim 11, in which encryption and decryption means (8, 9) for encrypting and decrypting the communication between the user and the computer (4) and/or the communication between the computer (4) and the target device (2) is provided.

14. A computer as claimed in claim 11, in which acoustic references for the speech recognition and/or information about the purchasing behavior of the user or similar is contained in the database (6).

15. A computer as claimed in claim 11, in which a recognition device for recognition of the communication means is provided.

16. A computer as claimed in claim 11, in which the interface (5) between the computer (4) and the target device (2) is formed by a data network (3), in particular the Internet.

17. A computer as claimed in claim 11, in which the communication means (1) are integrated with the computer (4).

18. A computer as claimed in claim 11, in which the database (6) for the user-specific data is integrated with the computer (4).

19. A computer as claimed in claim 11, in which a speech recognition device (10) is provided for acoustic output of the information.

20. A computer as claimed in claim 11, in which a device is provided for restricting the information transferred by the user to the target device in dependence on the user.

21. A computer as claimed in claim 11, in which the communication means (1) are formed by a mobile telephone.

22. A computer program product, which can be loaded directly into the internal memory of a digital computer and comprises sections of software code, in which the steps of the method in accordance with any of claims 1 to 10 are executed with the computer if the product is running on the computer.

23. A computer program product as claimed in claim 22, in which it is stored on a medium that can be read by a computer.
